(19) United States
(12) Patent Application Publication
(10) Pub. No.: US 2004/0187508 A1
(43) Pub. Date: Sep. 30, 2004

(54) Link for vehicle HVAC controls without wire harness

(76) Inventor: Soon Lye Chan, Rochester Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/395,489

(22) Filed: Mar. 24, 2003

(51) Int. Cl. B60H 1/32

(52) U.S. Cl. 62/244

(57) ABSTRACT

An HVAC system for a vehicle preferably utilizes a control panel which encodes operator request signals at the control panel prior to sending those signals to a driver module. In this way, complex wire harnesses are not required. A most preferred embodiment includes a wireless connection between a control input and a driver module for receiving control signals and driving appropriate components on the HVAC system. The control signals are preferably transmitted over a wireless link through RF technology. Alternatively, infrared signals may be utilized.

### BACKGROUND OF THE INVENTION

This application relates to the use of a link to connect input controls for a vehicle HVAC system to the module for affecting the desired control wherein a control signal is encoded at a control module.

Modern vehicles are being provided with more and more operator controlled electronic systems. Historically, vehicles have included HVAC controls such as air conditioning and heating controls, and entertainment controls such as a radio, etc.

In recent years, vehicles are being provided with additional driver inputs and various types of displays, such as navigation systems Typically, all inputs, displays and controls are housed in the instrument panel of the vehicle. The instrument panel in modern vehicles thus is being provided with more and more inputs and displays.

These inputs and displays are typically provided with an electrical link to the vehicle data bus, or alternatively, the various systems which are controlled by the controls or which affect the displays.

Thus, the area within an instrument panel is filled with numerous wire harnesses that must connect the control or the display to other systems or the data bus.

Many issues are raised with regard to the design of the controls, and the instrument panels by these numerous connections. As an example, the required volume of space within the instrument panel is larger than may be desired. Further, there are restrictions and complications on the routing of the wire harnesses within the instrument panel.

In particular, the HVAC controls have required thick wire harness cables and numerous connections. The prior HVAC controls have taken operator input requests, and sent a number of separate signals to a controller for the HVAC system. The separate signals being transmitted from the control panel to the HVAC system have required the wire harness cables.

### SUMMARY OF THE INVENTION

In a disclosed embodiment of this invention, a vehicle HVAC control is a thin panel that simply sends a signal to a driver module for the HVAC system. In particular, the thin control panel converts the operator input requests into control signals prior to transmitting those signals to the driver module. The signal could be sent as an RF signal, an infrared signal or other type wireless signal. In the case of the infrared signal, a conduit, such as a hollow hose may receive the RF signal and move it to the driver module. In one alternative embodiment, a pair of wires may be utilized to connect the control panel to the driver module. However, a separate wire for each of the several control signals is not required.

A simple RF control link, such as the type utilized in modern toy radio-controlled cars is preferably used for providing the above-referenced communication.

The present invention would thus reduce the space required in the instrument panel, and would also eliminate all of the size requirements and wire harness and routing issues mentioned above. The driver module may be mounted in the instrument panel, or may be mounted elsewhere.

These and other features of the present invention can be best understood from the following specification and drawings, the following of which is a brief description.

### BRIEF DESCRIPTION OF THE DRAWINGS

FIG. 1A shows a vehicle instrument panel.

FIG. 1B is a highly schematic view of portions of a vehicle HVAC system.

FIG. 2 is a schematic view of a first embodiment of this invention.

FIG. 3 schematically shows a second embodiment of this invention.

FIGS. 4A-4D show a first type of control option.

FIGS. 5A-5D show a second type of control option.

### DETAILED DESCRIPTION OF THE PREFERRED EMBODIMENT

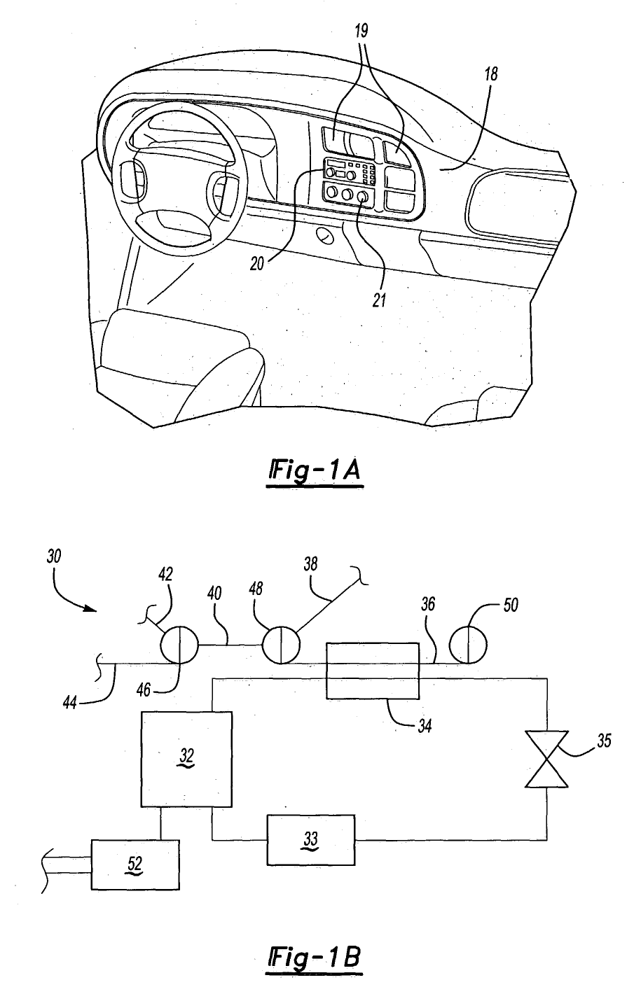

A vehicle interior is shown in FIG. 1A. As shown, the instrument panel 18 incorporates numerous displays 19, and controls such as the entertainment system 20. One other control illustrated is the HVAC control panel 21. As is known, switches and rotating knobs for adjusting a desired temperature, airflow direction, etc. are found in the HVAC control panel 21.

In a main feature of this invention, input signals from the switches are translated into coded signals at the control panel. By the term “coded,” this application would extend to any type signal processing wherein a signal is sent electronically such as by a wireless link using modulated RF signals. Alternatively, in one embodiment as shown below, this signal may be multiplexed over a single wire to convey information with regard to the several control switches.

FIG. 1B schematically shows a portion of an HVAC system. As known, there is a refrigerant circuit including a compressor 32, an evaporator 34, an expansion element 35 and a condenser 33. An electronic control 52 controls the operation of at least the compressor and various fans associated with the HVAC system 30. One further aspect of the HVAC system includes flow control or vent doors 46, 48 and 50. The airflow towards the cabin of the vehicle passes through at least two supply channels 36 and 38.

As shown, supply line 36 passes through the evaporator 34, and thus will be a source of cool air. Supply line 38 comes from a source of heat, such as is generally known in vehicle HVAC systems. The two lines 36 and 38 mix to reach a downstream passage 40. A vent door 48 controls the mixing of flow between the lines 36 and 38 passing to line 40. A further door 50 controls the supply of air to the line 36. Once air reaches passage 40, it should be at the desired temperature. Then, other vent doors such as vent door 46 control the flow between the foot area of the passenger cabin (passage 44) and the upper area of the passenger cabin (passage 42). Control 50 must thus control the position of the doors 46, 48 and 50 to achieve desired airflow conditions and directions within the vehicle cab. It should be understood that this is a highly schematic and simplified rendering of the overall HVAC system 30. There may be additional doors, flow passages, etc. Traditionally, the control 50 is provided with directions from an operator through a hard-wired connection between the control input panel 211, and the control 52. The controls may pass through the vehicle data bus, etc. but a wire harness has been used to connect input panel 21 to the control 52 in some fashion. As the present invention converts the signals into code at the control panel, the wire harness is no longer necessary with this invention.

FIG. 2 shows an embodiment of this invention 120. In embodiment 120, the HVAC control input module 122 includes a plurality of input members 121. The control module 122 is shown mounted in the instrument panel 18. Control module 122 need only be capable of receiving an input signal from the switches 121. The control module 122 would typically include the necessary circuitry for receiving input signals 121, and processing them through modulation techniques to produce a radio frequency output from a transmitter 123, shown schematically. That is, the desired control inputs are converted to a modulated or coded signal at the control module 122 prior to being transmitted. The technology to take an input control signal and convert it to a modulated RF signal that can be demodulated by a control is known. Thus, the receiver 125 associated with a control module 124 receives signals from the switches 121 without the requirement of a hard link. As shown, a wire harness 126 is provided with connectors to connect to wires 128 on the HVAC system 130. The detail of what control is affected and how the control is affected is no different than as now exists in the prior art. That is, the HVAC system 130 is shown schematically, however, the features of the invention do not extend to these details. Rather, it is the radio frequency link between the transmitter 123 and receiver 125 that is inventive here.

FIG. 3 shows another embodiment 158 having an HVAC control input switches 60 and a control module 62. Control modules 62 and switches 60 are identical to the embodiment of FIG. 2, other than the output is not a radio frequency modulated signal, but instead an infrared signal. The technology for creating and sending an infrared signal to convey and then decode control information is known in the art. The module 66 for driving the HVAC system 30 can decode infrared information, and sends appropriate control signals to system 30 as in the prior embodiment. However, since the infrared signal is preferably directed at the module 66, a tube 64 having a hollow interior connects from an infrared output member 67 to an infrared receiving member 68. In this manner, appropriate control signals can be sent.

As is known, dependent on the input received at the input modules 122 or 62, the necessary control signals may be one necessary to actuate or stop operation of motors associated with the HVAC system, or to change the position of the vent doors. Again, what control is required by a particular input is as known in the art. This invention is directed to a way of transmitting control signals.

Again, the controls and circuitry necessary for creating the communication link of either the FIG. 2 or FIG. 3 embodiment are known generally in the art. It is the application of such controls in providing the particular features in an HVAC vehicle control system.

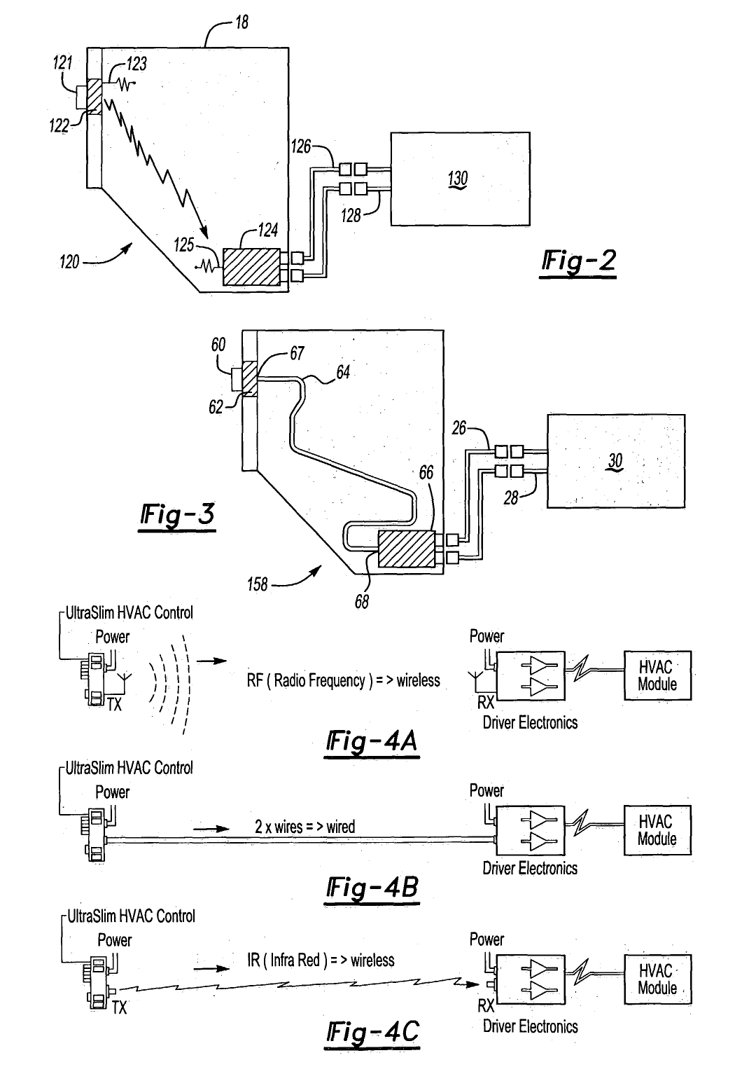

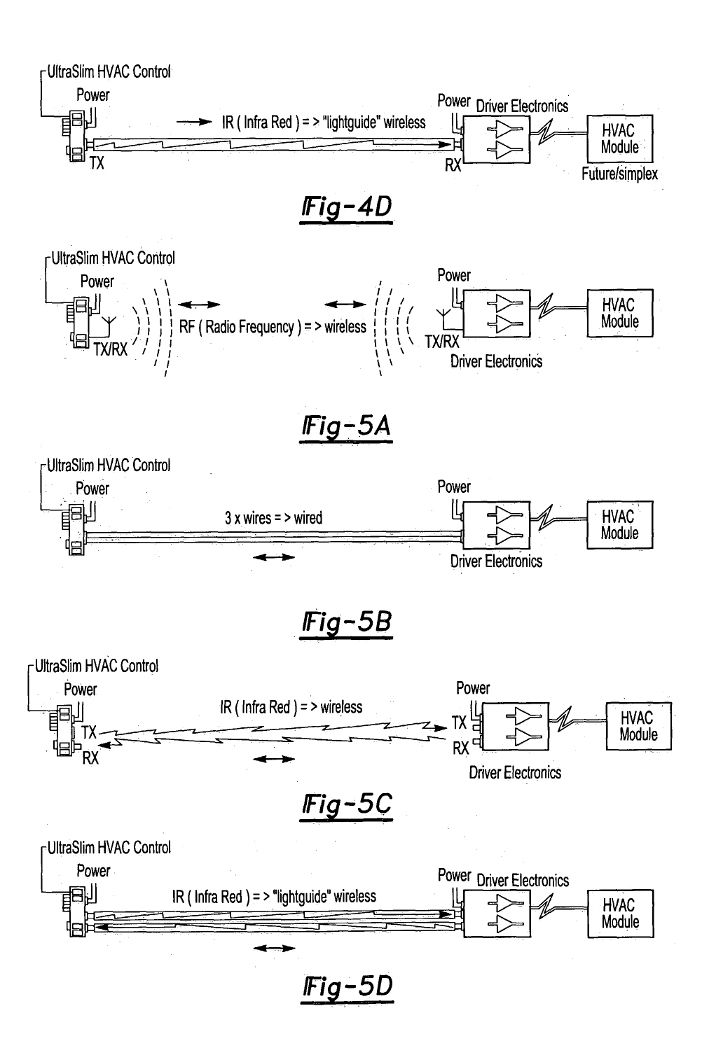

FIGS. 4A-4D show several options for the basic features of this invention. In a first embodiment shown in FIG. 4A, the control panel sends an RF signal to the driver module. In FIG. 4B, wires are utilized. With this embodiment, only a pair of wires are necessary, with the signals at the control panel being encoded and then multiplexed over the wire to the driver module. FIGS. 4C and 4D show the infrared variations as described above. The FIGS. 4A-4D embodiments are all “simplex” in that signals only go from the control panel to the driver module.

FIGS. 5A-5D are similar to the FIGS. 4A-4D embodiments except that the signals are “duplex” meaning that the driver module will send signals back to the control panel. These return signals can be as simple as acknowledgements that the previously sent control signals have been received by the driver module.

While preferred embodiments have been disclosed, a worker in this art would recognize that modifications would come within the scope of this invention. Thus, the following claims should be studied to determine the true scope and content of this invention.

1. An HVAC system for a vehicle comprising:
an input control module, to be permanently mounted in a vehicle cab, and including a plurality of input devices for adjusting a desired temperature for receiving input signals from an operator, and creating output signals, said input control module being provided with a transmitter to send wireless signals conveying control information;
a receiver for receiving said wireles control signals, said receiver being a part of a driver module for an HVAC system, and an HVAC system receiving control signals from said driver module.

2. A system as set forth in claim 1, wherein said wireless signals are radio frequency signals.

3. A control system as set forth in claim 1, wherein said wireless signals are infrared signals.

4. An HVAC system for a vehicle comprising A system as set forth in claim 3, wherein:
an input control module for receiving input signals from an operator, and creating output signals, said input control module being provided with a transmitter to send wireless signals conveying control information, said wireless signals being infrared signals;
a receiver for receiving, said wireless signals, said receiver being a part of a driver module for an HVAC system, and an HVAC system receiving control signals from said driver module; and
said infrared signals are passed through a hollow tube member between said input control module and said driver module.

5. An HVAC system for a vehicle comprising A system as set forth in claim 1, wherein:
an input control module for receiving input signals from an operator, and creating output signals, said input control module being provided with a transmitter to send wireless signals conveying control information;
a receiver for receiving said wireless signals, said receiver being a part of a driver module for an HVAC system, and an HVAC system receiving control signals from said driver module; and
said HVAC system receives both motor control signals and vent door position control signals from said wireless signals.

6. A system as set forth in claim 1, wherein said input control module and said driver module are both received within a vehicle instrument panel.

7. An HVAC system for a vehicle comprising:
an input control module adapted to be mounted in a vehicle instrument panel, and for receiving input signals from an operator, and creating output signals that are encoded in said control module for transmission to a receiver;
a receiver for receiving said output control signals, said receiver being a part of a driver module for an HVAC system, and an HVAC system receiving control signals from said driver module.

8. An HVAC system as set forth in claim 7, wherein said output signals are sent by a wireless connection between said input control module and said driver module receiver.

9. An HVAC system as set forth in claim 7, wherein a wire link connects said input control module and said receiver, and said signals being sent over a multiplexed connection.

10. An HVAC system for a vehicle comprising:
an input control module for receiving input signals from an operator, and creating output signals, said input control module being provided with a transmitter to send a wireless signals conveying control information;
a receiver for receiving said wireless control signals, said receiver being a part of a driver module for an HVAC system, and an HVAC system receiving control signals from said driver module;
said output signals including control signals for said HVAC system to control at least one motor associated with said HVAC system, and to control the position of vent doors associated with said HVAC system; and
said input control module and said driver module being received within a vehicle instrument panel.

11. A system as set forth in claim 10, wherein said wireless signals are radio frequency signals.

12. A control system as set forth in claim 10, wherein said wireless signals are infrared signals.

13. A system as set forth in claim 10, wherein said infrared signals are passed through a hollow tube member between said control module and said driver module.

14. An HVAC system as set forth in claim 7, wherein said receiver and said driver module are also adapted to be mounted in a vehicle instrument panel.
